(19) United States
(12) Patent Application Publication
(10) Pub. No.: US 2005/0287512 A1
(43) Pub. Date: Dec. 29, 2005

(54) Specimen storing device and method

(76) Inventors: Herbert M. Cullis, Gaithersburg, MD (US); Phillippe Jean Broussard, Finksburg, MD (US)

Correspondence Address: ROSSI, KIMMS & McDOWELL LLP., P.O. BOX 826, ASHBURN, VA, 20146-0826, US

(21) Appl. No.: 10/873,255

(22) Filed: Jun. 23, 2004

(51) Int. Cl. A01N 1/02

(52) U.S. Cl. 435/1.3; 435/307.1

(57) ABSTRACT

A closed system for withdrawing, measuring, and isolating discrete quantities of liquid specimen for cryogenic preservation and recovery includes a fluoroplastic storage tube, an aspirating device, such as a syringe, and an impermeable barrier. The aspirating device can be used to meter exact amounts of specimen into the tube, and then to isolate the specimen within the confines of the tube during freezing, storage, thawing. The specimen in the tube can be withdrawn into the same syringe. While encapsulated, the specimen is protected from contact with air, gasses, and moisture in the cryogenic atmosphere. The specimen can be recovered from the frozen state without compromising sterility or exposure to any external environment.

### BACKGROUND

Carefully frozen specimens, particularly of biological nature, can be preserved for indefinite number of years. Specimens can include diverse fluids, such as liquids, suspensions, cellular suspensions, chemicals, and materials, vaccines, cells for cellular therapy, cells for cellular vaccination, genes and materials that express genes, constructs of organic chemicals that contain cells for forensic preservation, cells for future infusion, and cells for future study, for example. Preserving unknown specimens, such as archaeological and forensic materials, allows for later examination.

In many cases, it is desirable to freeze specimens at temperatures below the freezing point of water (0° C.), carbon dioxide (−76° C.), and oxygen (−181° C.). One of the ways specimens can be frozen is by immersion in or suspension above liquid nitrogen (−197° C.). This is frequently practiced in medical and biological research fields. Preserving specimens without adding contaminants (i.e., by maintaining sterility and cleanliness of the specimen) is particularly critical in those instances where the specimen will be later used for therapeutic or diagnostic purposes.

While frozen, the specimen can experience the following processes: “freezer burn” (dehydration), fugacity (hydration), evaporation (loss of any volatile material), or solventing (gaining of fluid by diffusion and solution). None of these processes are desirable, as they can alter the content of the specimen. Presently, specimens to be cryogenically preserved are placed into containers that have removable covers for addition and removal of the specimen. One such container is known as a “Nunc” vial. Such openable containers are prone to contamination, and as such are considered an “open” system (i.e., the container must be opened to the environment to fill or remove the specimen. It is frequently necessary to recover every drop of the specimen, and not leave any behind when removing the specimen for further procedures. This is particularly true when the specimen is severely limited, such as stem cells, or when it must be quantitated, or when it is infectious.

While undergoing cryogenic preservation, it is vital to protect the specimen from the harsh cryogenic environment, which includes frost, CO₂ gas, oxygen, and other reactive substances that can change, alter, contaminate, or dilute the specimen. The present state of the art, however, is to pipette or dispense specimens into plastic vials having a capacity of storage less than 5 milliliters and having a snap fit cap or screw top cap. Dispensing specimens into such vials requires removing the cap and dispensing the specimens into the air in the vicinity of the top of the vials, providing opportunity for contaminates to enter into the specimens, and for infection and contamination by the specimens. Contaminating specimens is undesirable if they are to be used for forensic study or if the specimen is to be infused or otherwise used to diagnose or therapeutically to treat diseases. Dispensing into a vial is particularly hazardous if the specimen is infectious, such as is the HIV virus, certain bacteria, or if the specimen is toxic such as is radioactive materials, biologic toxins, or toxic chemical materials.

Storing in such a vial includes airspace that permits reaction of the specimen with whatever may be present in the airspace. And storage in a vial containing airspace permits evaporation, sublimation, and absorption by the specimen. During freezing and storage in liquid nitrogen, the airspace within a vial will experience volumetric reduction (contraction) when moisture is frozen to ice during freezing at 0° C., and the airspace will be further reduced (contracted) when carbon dioxide becomes solid dry ice at −76° C., and the airspace will be further reduced when oxygen becomes liquid at −181° C. The reduction is space is filled by the ambient nitrogen. When removed from the liquid nitrogen, the airspace is then overfilled as the oxygen, carbon dioxide, and water vapor change state back to gas. This causes the contents of the vial to expand, which can frequently cause the top to pop off, inviting contamination.

Accordingly, there remains a need for a cryogenic preservation device or method that avoids the problems arising from cryogenic preservation. The present invention addresses this need.

### SUMMARY OF THE INVENTION

The present invention relates to a device and method for storing a specimen, particularly for cryogenic preservation.

One aspect of the present invention thus is a device for storing a specimen. The present device can include a tubular storage unit and a barrier. The storage unit is connectable to an aspirating device at a proximal end thereof and to a reservoir containing a specimen at a distal end thereof. The barrier can hermetically enclose the tubular storage unit after withdrawing the specimen into the tubular storage unit.

The tubular storage unit can be made of an inert material that does not contaminate or interact with the specimen, and does not become brittle at cryogenic preservation temperatures. In this respect, the tubular storage unit can be made of fluoroplastic. In particular, the tubular storage unit can be made from one of fluoroethylene propylene and co-polymers of hexafluoro ethylene and hexafluoro propylene.

The specimen can be completely suspended within the tubular storage unit, and the distal end of the tubular storage unit can be sealed and cut after withdrawing a desired amount of specimen into the tubular storage unit before hermetically enclosing the tubular storage unit in the barrier, which can be an envelope. The envelope can have a first compartment for hermetically enclosing the tubular storage unit and a second compartment for separately hermetically enclosing the aspirating device. The envelope can be made of polyimide or fluoroethylene propylene.

The present device can further include an aspirating device and a coupling device for coupling the proximal end of the tubular storage unit to the aspirating device. The coupling device can be a luer fitting and the aspirating device can be a syringe. The syringe can be hermetically sealed in the barrier after withdrawing the specimen into the tubular storage unit. The specimen can be withdrawn into the syringe after the specimen has been cryogenically preserved and then thawed. The present device can also include a second barrier that hermetically seals the barrier containing the specimen.

The tubular storage unit can be a tube having volumetric markings for measuring the volume of the specimen contained inside the tube. The aspirating device also can have means for measuring the volume of the specimen withdrawn in the tube, in addition to the tube markings or in lieu thereof. In particular, the tubular storage unit can be a tube having a relatively small diameter relative to a length thereof to form a meniscus of the specimen to allow volumetric measurement of the specimen by measuring the length of the specimen contained in the tube. In this regard, an inner diameter of the tube can be between 1-3 mm.

Another aspect of the present invention is a method of storing a specimen. The method can comprise providing the tubular storage unit, which is connected to the aspirating device at a proximal end thereof and to the reservoir containing a specimen at a distal end thereof, withdrawing the specimen from the reservoir into the tubular storage unit with the aspirating device, sealing and cutting the tubular storage unit at a portion spaced from a trailing end of the specimen contained in the tubular storage unit, and hermetically enclosing the tubular storage unit in a barrier. The aspirating device also can be hermetically sealed with the tubular storage unit. The aspirating device can be disconnected from the tubular storage unit before hermetically sealing the barrier. The method can further include cryogenically preserving the specimen. In this respect, the barrier can be hermetically sealed in the second barrier.

### BRIEF DESCRIPTION OF THE DRAWINGS

FIG. 1 schematically illustrates the present system.

FIG. 2 schematically illustrates an embodiment of an aspirating or vacuuming device.

FIG. 3 is similar to FIG. 2, but with the specimen in the ready to freeze condition.

### DETAILED DESCRIPTION

The present invention can be used to store and preserve specimens in a frozen state, without contaminating the same. More specifically, the present invention can be used to aspirate a volumetrically measured specimen, store the specimen, and recover the specimen in a closed environment. According to the present invention, the specimen is completely or at least substantially isolated from the reactive agents, such as vapors, gasses, and liquids. The present invention uses a closed system where the specimen is completely or substantially isolated from the preserving environment.

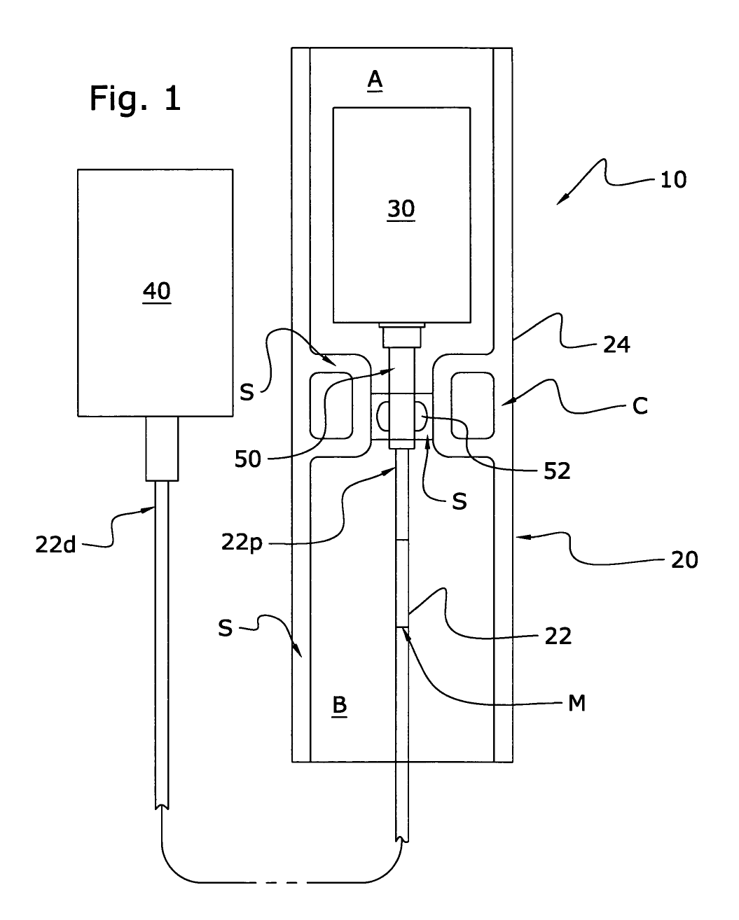

Referring to FIG. 1, the present system 10 includes a storing device 20 and an aspirating or vacuuming device 30. The storing device 20 can include a storage unit 22 and a barrier 24. In the illustration, the storage unit is a tube or tubular in shape, initially having both of its ends open.

The dimension of the tube is selected so that a desired amount of specimen (in fluid) is completely contained in the tube so that the specimen is exposed only at the area where the leading and trailing ends of the specimen contained within the tube. That is, the total exposed area only equals twice the inner cross-sectional area of the tube. The tube has a relatively small diameter in relation to its length to allow formation of a meniscus of the specimen. This allows volumetric measurement of the specimen by measuring the length of the specimen contained in the tube. For example, the tube can have an inner diameter ranging between 1-3 mm, a 1 mm diameter allowing measurement of specimen that is less than one cubic centimeter.

The tube can have a marking, scale, or measurement indicator M that can measure an exact amount of the specimen to be stored. The specimen is thus contained in a close fitting storage container, which is made of an inert material that will not cause contamination or interact with the specimen. The storage container is designed so that substantially no or very little airspace contacts the specimen. One of the inert materials that can be used for this purpose is a fluoroplastic.

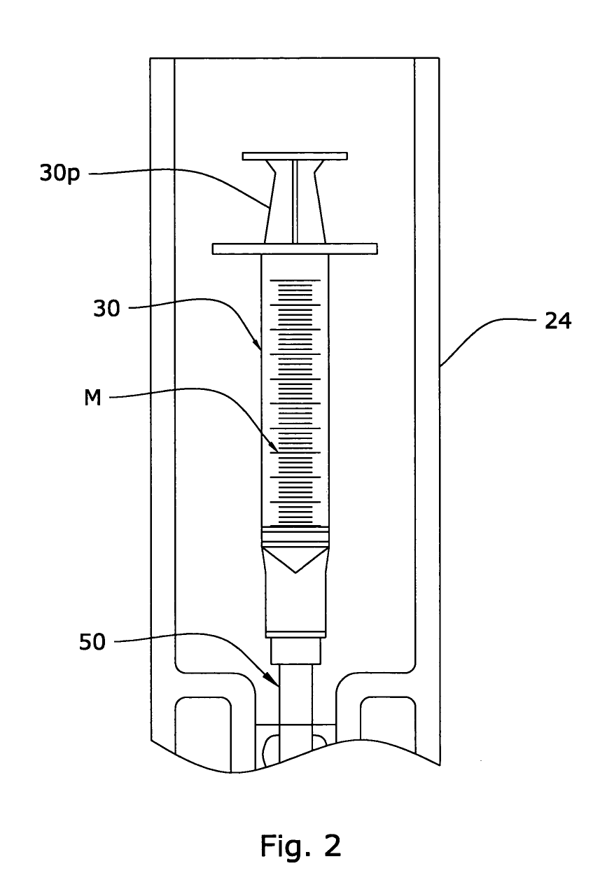

One end (distal) 22d of the tube 22 can be directly connected or connected via a sterile or aseptic transferring mechanism to a reservoir 40 containing a specimen. The reservoir 40 itself can be another tube, which can also be made of fluorocarbon plastic. Alternatively, the tube 22 can be pre-connected to the reservoir 40. The other end (proximal) 22p of the tube 22 can be connected to the aspirating device 30, which can include a syringe (as schematically illustrated in FIG. 2), a bulb, or any suitable pump, electrical or mechanical, such as a peristaltic pump. The aspirating device 30 also can be integral with the tube 22. For instance, a bulb or a syringe can be integrally formed with the tube. The tube is configured so that the specimen can enter through its distal end and exit its proximal end.

The barrier 24 can be any suitable type that can be hermetically sealed. The illustrated embodiment represents the barrier as a hermetically sealable envelope. The envelope can have first and second compartments A, B. The first compartment A can be configured to contain and envelope the aspirating device 30. The second compartment can be configured to contain the tubular storage unit 22. The proximal end 22p of the tube 22 can be inserted into the first compartment A. Alternatively, as illustrated in FIGS. 1-3, an adapter 50, such as a conventional luer lock or fitting, can be connected to the proximal end 22p of the tube 22. The adapter 50 can be configured to connect to the aspirating device 30. For complete sterility, the first and second compartments A and B can be isolated from each other if desired. In that instance, the envelope at an intermediate portion C formed between the first and second compartments A, B seals the outer wall of the adapter 50 or the proximal portion of the tube. In this regard, the intermediate portion can extend a length sufficient to cause a complete seal with the outer wall of the adapter/tube, and also lock the same against rotational and longitudinal movement relative to the envelope.

The envelope 24 is designed to hermetically envelope and seal in the storage unit 22 and the aspirating device 30 after the specimen is introduced into the storage unit. The envelope itself can be formed of polyimide or fluoroethylene propylene, for instance. Two sheets of such material can be heated along opposite sides (longitudinally) to form an envelope having sealed sides. Sealing and cutting can be done simultaneously, such as by using ACCSEAL's (San Marcus, Calif.) Model 540, which is commercially available. The intermediate portion C can be formed by additionally heat sealing the portion extending inwardly of the longitudinal sides to form a narrow passage or waist sufficient to permit passage of the adapter/tube.

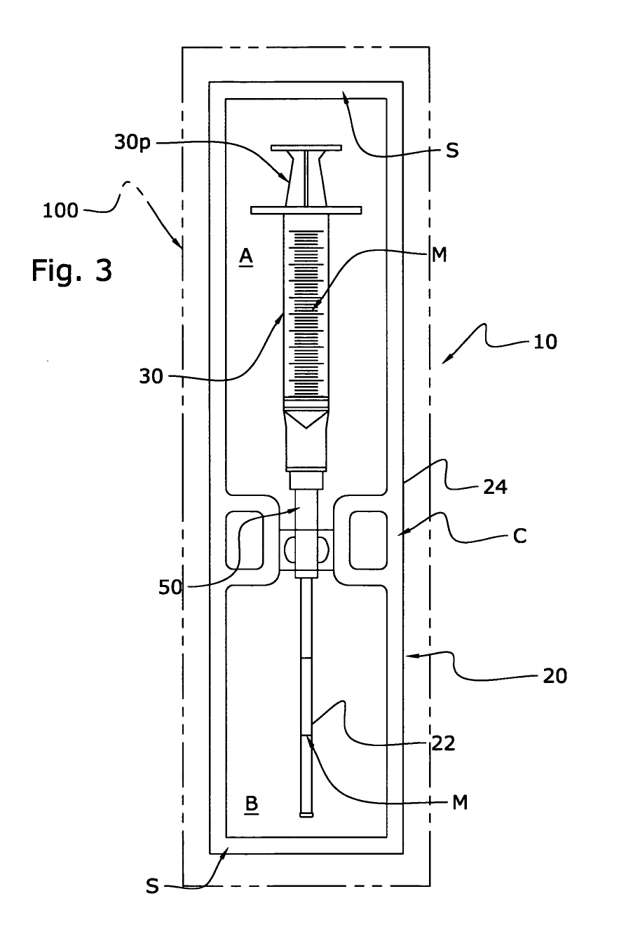

In operation, the proximal end 22p of the tube 22 or the same connected to the adapter 50 is inserted through, and can be bonded to the intermediate portion C of the envelope. The adapter/tube can be bonded to the envelope at the intermediate portion C, such as by heat bonding or welding. For instance, bonding can be accomplished by bringing the temperature of both materials to their melting point under pressure and permitting the materials to meld together before cooling. This process is generally referred to as “heat bonding” or “welding.” Thereafter, the aspirating device, such as a syringe (FIGS. 2 and 3), can be connected to the adapter 50 and the proximal end 22p of the tube 22 can be connected to the adapter (if one is used). Alternatively, the proximal end of the tube can be directly connected to the aspirating device. Note that the order of assembling the aspirating device and adapter/tube is not critical. Preferably, the adapter and tube are preassembled before placing them in the envelope. For instance, the aspirating device and the tube can be connected outside the envelope and the distal end of the tube can be inserted through the intermediate portion. Once the aspirating device is positioned so that it is completely enveloped in the first compartment of the envelope, the adapter (if used) or the tube can be sealed or bonded to the envelope at the intermediate portion. Once the aspirating device and the tube is positioned in the envelope, the distal end 22d of the tube 22 can be connected to the reservoir containing the specimen. The present assembly can be rendered sterile by various methods including autoclave, ethylene oxide gas, and radiation sterilization before storing the specimen.

The specimen inside the reservoir is withdrawn into the tube by aspirating the tube from the proximal end of the tube using the aspirating device, such as a syringe, by pulling back its plunger. The amount (volume) aspirated into the tube can be read from the markings, scale, etc., M on the syringe barrel or from the similar graduations or markings M formed on the tube itself. Both can be used to check for accuracy. After the desired volume is withdrawn into the tube, a small amount of air can be drawn following the specimen. This is to provide a reference for measuring the length of the tube and to delineate the point for sealing the tube. After the specimen is in the tube, the tube is sealed and parted at the filling end by any suitable means. One such means is fusing the end of the tube by melting the tube in a welding mode. In this regard, the tube can be made of a thermoplastic material that can be sealed closed by thermal melting when squeezed closed. The welded end can extend beyond the end of the envelope. If the welded tube extends beyond the envelope, it can be folded back into the envelope so that it is fully enveloped within the envelope. The envelope that already covers the aspirating device and the tube can then be sealed at both ends of the envelope, hermetically sealing the same to ensure a sterile, secondary barrier 100 (shown in phantom in FIG. 3). Alternatively, the aspirating device can be disconnected and removed after the tube has been filled and sealed before hermetically sealing the envelope at both ends thereof. This sterile barrier permits handling of the tube and syringe without contaminating them. The second barrier, such as another envelope of the similar type, can be used to seal the first envelope containing the specimen to prevent liquid nitrogen and other contaminates from being conveyed into the final area where the inner envelope is opened.

Thermoplastic, thermosetting, or sintered fluoroplastic materials, such as fluoroethylene propylene (FEP), co-polymers of hexafluoro ethylene and hexafluoro propylene, and other fluoronated plastics, are preferred for the tube because it does not become brittle at liquid nitrogen temperatures and can withstand the volume changes associated with freezing without fracture. The diameter of the tube can be selected such that the specimen occupies a space that is relatively long compared to its diameter. Thus, a tube provides a container that limits the surface of the frozen specimen to a very small area, thereby limiting any surface activity. The entire assembly can be frozen conventionally, such as by placing in a controlled rate freezer. The specimen is hermetically sealed from the environment and suspended frozen within the tube. Freezing fluorocarbon tubes to temperatures as low as −200° C. is tolerated as well as immersion in liquid nitrogen. Fluorocarbon plastics contain no extractable chemicals and thus will not give up any chemical to the specimen, are hydrophobic (non-wettable), are virtually devoid of moisture, do not react with any known chemicals or biologics, and will not adsorb or absorb any biologic material. Moreover, fluorocarbon plastics have no plasticisers. The fluorocarbon thermoplastic tube thus provides these necessary properties: low surface energy, ability to stretch and flex while frozen and while undergoing freezing and thawing, and the ability to stretch and flex while at temperatures that permit phase change of carbon dioxide (−76° C.).

Indeed, many biologics metabolize sugars to produce carbonic acid or carbon dioxide during the time before becoming frozen in water ice. The aqueous fluid therefore can contain large amounts of dissolved carbon dioxide. Any dissolved carbon dioxide and the carbonic acid that may become carbon dioxide while being frozen or thawed, can undergo phase change at its triple point, at about −65° C. to −76° C. Since phase change will involve volumetric change, the use of fluorocarbon thermoplastics permits such volumetric change by stretching without disruption of the integrity of the sterile barriers. This invention eliminates the possibility of airspace contractions and expansion causing bursting of the container because the container can expand and contract to accommodate phase changes.

Following cryogenic preservation of the specimen at about −197° C. (or lower), the entire assembly can be thawed conventionally, such as by placing into a 37° C. water bath. After thawing, the outer envelope, if used, is removed. The sealed end of the storage tube can be chemically sterilized such as by treatment with alcohol or iodine, or the like, and can be aseptically opened with a sterile knife or sterile needle to admit air and permit the contents of the tube to be drawn into the syringe. The syringe can be uncoupled from the tube by disconnecting the luer fitting. By following the outlined procedure, the thawed specimen can be completely recovered from the tube into a sterile syringe or other device all within a closed system, without having to expose the specimen to the ambient environment. Moreover, thawing and recovering of the specimen can be made in a sterile manner without the need for an external sterile environment such as a clean room hood. The closed system according to the present invention also protects the specimen from contact with liquid nitrogen or other contaminants that may exist in the freezing, thawing, or handling environment.

The present system and method of storing completely or at least substantially confines the specimen without exposing the surface of the specimen to outside vapors, and without the opportunity for the specimen to evaporate, dehydrate, or rehydrate.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

1. A device for storing a specimen, comprising:
a tubular storage unit connectable to an aspirating device at a proximal end thereof and to a reservoir containing a specimen at a distal end thereof; and
a barrier that hermetically encloses the tubular storage unit after withdrawing the specimen into the tubular storage unit.

2. A device according to claim 1, wherein the tubular storage unit is made of an inert material that does not contaminate or interact with the specimen, and does not become brittle at cryogenic preservation temperatures.

3. A device according to claim 2, wherein the tubular storage unit is made of fluoroplastic.

4. A device according to claim 3, wherein the tubular storage unit is made from one of fluoroethylene propylene and co-polymers of hexafluoro ethylene and hexafluoro propylene.

5. A device according to claim 1, wherein the specimen is completely suspended within the tubular storage unit, and the distal end of the tubular storage unit is sealed and cut after withdrawing a desired amount of specimen into the tubular storage unit before hermetically enclosing the tubular storage unit in the barrier.

6. A device according to claim 1, wherein the barrier is an envelope.

7. A device according to claim 6, wherein the envelope has a first compartment for hermetically enclosing the tubular storage unit and a second compartment for separately hermetically enclosing the aspirating device.

8. A device according to claim 6, wherein the envelope is made of polyimide or fluoroethylene propylene.

9. A device according to claim 1, further including an aspirating device and a coupling device for coupling the proximal end of the tubular storage unit to the aspirating device.

10. A device according to claim 9, wherein the coupling device is a luer fitting.

11. A device according to claim 10, wherein the aspirating device is a syringe.

12. A device according to claim 11, wherein the syringe is hermetically sealed in the barrier after withdrawing the specimen into the tubular storage unit.

13. A device according to claim 1, wherein the tubular storage unit is a tube having volumetric markings for measuring the volume of the specimen contained inside the tube.

14. A device according to claim 1, further including an aspirating device, wherein the tubular storage unit is a tube and the aspirating device has means for measuring the volume of the specimen withdrawn in the tube.

15. A device according to claim 11, wherein the specimen is withdrawn into the syringe after the specimen has been cryogenically preserved and then thawed.

16. A device according to claim 1, wherein the tubular storage unit is a tube having a relatively small diameter relative to a length thereof to form a meniscus of the specimen to allow volumetric measurement of the specimen by measuring the length of the specimen contained in the tube.

17. A device according to claim 16, wherein an inner diameter of the tube is between 1-3 mm.

18. A device according to claim 1, further including an outer barrier for hermetically sealing the barrier.

19. A method of storing a specimen, comprising the steps of:
providing a tubular storage unit connected to an aspirating device at a proximal end thereof and to a reservoir containing a specimen at a distal end thereof;
withdrawing the specimen from the reservoir into the tubular storage unit with the aspirating device;
sealing and cutting the tubular storage unit at a portion spaced from a trailing end of the specimen contained in the tubular storage unit;
hermetically enclosing the tubular storage unit in a barrier.

20. A method according to claim 19, wherein the aspirating device is also hermetically sealed with the tubular storage unit.

21. A method according to claim 20, wherein the aspirating device is disconnected from the tubular storage unit before hermetically sealing the barrier.

22. A method according to claim 20, further including the step of hermetically sealing the barrier in a second barrier.

23. A method according to claim 20, further including the step of cryogenically preserving the specimen.

24. A method according to claim 23, wherein the aspirating device is a syringe, the method further including the step of withdrawing the specimen into the syringe after the specimen has been thawed.

25. A method according to claim 19, wherein the tubular storage unit is made of fluoroplastic.

26. A method according to claim 19, wherein the barrier is an envelope made of polyimide or fluoroethylene propylene.

27. A method according to claim 24, further including a coupling device for coupling the proximal end of the tubular storage unit to the syringe.

28. A method according to claim 19, wherein the tubular storage unit is a tube having volumetric markings for measuring the volume of the specimen contained inside the tube.

29. A method according to claim 19, wherein the amount of specimen withdrawn into the tube is measured using predetermined markings formed in the tubular storage unit.
